(19) United States
(12) Patent Application Publication
(10) Pub. No.: US 2009/0268335 A1
(43) Pub. Date: Oct. 29, 2009

(54) NEUTRALIZING FLYING HEIGHT SENSITIVITY OF THERMAL POLE-TIP PROTRUSION OF MAGNETIC SLIDER

(76) Inventors: Fu-Ying HUANG, San Jose, CA (US); Jia-Yang Juang, Santa Clara, CA (US); Timothy C. Strand, San Jose, CA (US)

Correspondence Address: HITACHI C/O WAGNER BLECHER LLP, 123 WESTRIDGE DRIVE, WATSONVILLE, CA, 95076, US

(21) Appl. No.: 12/110,235

(22) Filed: Apr. 25, 2008

(51) Int. Cl. G11B 21/02

(52) U.S. Cl. 360/75

(57) ABSTRACT

A method for neutralizing the flying height sensitivity associated with thermal pole-tip protrusion (T-PTP) of an air bearing slider comprises creating head material data and air bearing surface (ABS) compensation data, based on which a head/ABS design is created. The head material data comprises at least one material property that is dependent on the manner in which the material is fabricated, such as the coefficient of thermal expansion of a material deposited using a certain deposition process. The ABS compensation data comprises data about how respective ABS features affect air bearing pressure and, therefore, ABS compensation. A protrusion profile is determined for the head/ABS design, and whether or not this protrusion profile meets particular design criteria is then determined. The head/ABS creating and determining process can be iterated if necessary to arrive at a head/ABS design which provides neutral flying height sensitivity to a range of operational temperatures.

### TECHNICAL FIELD

Embodiments of the invention relate generally to the field of hard disk drives and, more specifically, to neutralizing the flying height sensitivity associated with thermal pole-tip protrusion (T-PTP) of an air bearing slider.

### BACKGROUND ART

Electronic computing devices have become increasingly important to data computation, analysis and storage in our modem society. Modem direct access storage devices (DASDs), such as hard disk drives (HDDs), are heavily relied on to store mass quantities of data for purposes of future retrieval. As such long term data storage has become increasingly popular, and as the speed of microprocessors has steadily increased over time, the need for HDDs with greater storage capacity to store the increased amount of data has also steadily increased.

Hard disk drive devices are configured with read/write heads for reading data from and writing data to rotating disks. One distinguishing characteristic of hard disk technology that makes it different from how floppy disks, VCRs and tape decks operate, is that the read/write heads are typically not designed to make contact with the media during read and write operations. Essentially, the reason for this is that due to the high speed at which the disks spin, and the need for the heads to frequently scan from side to side to different tracks, allowing the heads to contact the disk would result in unacceptable wear to both the delicate heads and the media.

### FLY HEIGHT

A typical drive head floats over the surface of the disk during read and write operations such that the head does not physically touch the corresponding disk. The amount of space between a head and a corresponding disk is called the “flying height” or “fly height”. The read/write head assemblies are spring-loaded, using the spring characteristic of the corresponding suspension or arm, which causes the air bearing slider on which the head is coupled to press against the disk when the disk is stationary. When the disk spins up to operating speed, the high speed causes air to flow under the sliders and lift them off the surfaces of the disk. Therefore, the air bearing surface design configuration has a significant effect on the flying height of the head.

The ever increasing demand for higher capacity storage devices continues to challenge HDD manufacturers to find innovative solutions for fundamental magnetic recording technology issues. One such issue is how to effectively read data and write new data over a wide range of operating temperatures and read/write duty cycle conditions. An important parameter affecting error rate performance is the fly-height. A key variable of fly-height is the read/write elements protrusion towards the recording disk. This protrusion changes with temperature and read/write duty cycle, thereby affecting the spacing with the recording disk. Controlling the spacing of the head read/write elements relative to the recording media becomes more and more critical for each successive generation of higher areal density products, hence, thermal fly-height control (TFC) technology was developed.

Protrusion refers to the physical distance that the read/write elements extend towards the disk surface relative to their initial position at some reference or nominal temperature. The read/write elements of a magnetic head slider comprise thin layers of different materials, for example, a substrate, write poles, a coil, an insulation layer, a read sensor, shields, an undercoat, an overcoat, etc. FIG. 3 is a diagram illustrating an example air bearing head slider 300 structure and a corresponding protrusion profile 320. Head slider 300 comprises a substrate 302, on which a first shield (S1) 304, a reader element 306, a second shield (S2) 308, a first pole (P1) 310, a coil 312, a stitch pole 314, a main pole 316, and a trailing shield 318 are deposited or otherwise constructed. The foregoing head components are covered with an overcoat 319.

Because of the difference in the coefficient of thermal expansion (CTE) of the various head materials, the pole-tip of the write pole protrudes below the air bearing surface plane when the ambient temperature rises. During typical operation the heating of the motor that drives the disk causes an elevation of the operational air temperature. For example, the operational air temperature may rise from room temperature to as high as 85° C. In such scenarios a large temperature-induced pole-tip protrusion (T-PTP) is created, which causes a significant concern about the head-disk interface reliability. This temperature-induced pole-tip protrusion is different from the intentional protrusion actuated via the TFC system, and is generally undesirable when unmanaged.

Typically, the fly height without TFC actuation is deliberately designed at a higher level to avoid head-disk contact for some heads which fly lower than others due to manufacturing tolerances. However, for those heads that fly higher without actuation, a much higher TFC heating power is usually required, which can cause detrimental effects on head reliability.

As can be appreciated, many factors affect the operational fly height of a magnetic recording read/write head. These factors generally include mechanical, thermal and aerodynamic characteristics of the head. Thus, allowing for operational variations in these factors remains a challenge, especially in view of the minimal fly heights which are desirable with current high areal density magnetic recording devices.

### SUMMARY OF EMBODIMENTS OF THE INVENTION

A method for neutralizing the flying height sensitivity associated with thermal pole-tip protrusion (T-PTP) of an air bearing slider is described. Head material data and air bearing surface (ABS) compensation data are created, based on which a head/ABS design is created. The head material data comprises at least one material property that is dependent on the manner in which the material is fabricated, such as the coefficient of thermal expansion of a material deposited using a certain deposition process. The ABS compensation data comprises data about how respective ABS features affect air bearing pressure and, therefore, ABS compensation. A protrusion profile is determined for the head/ABS design, and whether or not this protrusion profile meets particular design criteria is then determined. The head/ABS creating and determining process can be iterated if necessary to arrive at a head/ABS design which provides neutral flying height sensitivity, i.e., neutral sensitivity of the flying height to a range of operational temperatures.

A hard disk device comprising an air bearing slider assembly having neutral flying height sensitivity to temperature changes is described. The air bearing slider comprises a read/write head, and an undercoat and/or overcoat having a lower coefficient of thermal expansion than the substrate on which the read/write head is constructed. The air bearing slider further comprises an air bearing surface that compensates, over a particular range of operational temperatures, for changes in flying height of a pole-tip of the write element which are based in part on the head material structure, including the undercoat and/or overcoat.

### BRIEF DESCRIPTION OF THE DRAWINGS

The accompanying drawings, which are incorporated in and form a part of this specification, illustrate embodiments of the invention and, together with the description, serve to explain the principles of the invention. The drawings are used merely to illustrate principles of the illustrated embodiments, and it is understood that components described in these embodiments have not been drawn to scale.

FIG. 1 illustrates a side view of a disk drive system, according to an embodiment of the invention.

FIG. 2 illustrates a top view of a disk drive system, according to an embodiment of the invention.

FIG. 3 is a diagram illustrating an example air bearing head slider structure and a corresponding protrusion profile.

FIG. 4 is a flow diagram illustrating a process for neutralizing flying height sensitivity of thermal pole-tip protrusion, according to an embodiment of the invention.

FIG. 5 is a diagram illustrating an example of a desired protrusion profile 520 for a corresponding example air bearing head slider 500, according to an embodiment of the invention.

FIGS. 6A-6D are diagrams illustrating various cases studied to show the effectiveness of the teachings and embodiments presented herein.

### DETAILED DESCRIPTION OF EMBODIMENTS OF THE INVENTION

Reference will now be made in detail to embodiments of the present technology, examples of which are illustrated in the accompanying drawings. While the technology will be described in conjunction with various embodiments, it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well known methods, procedures, and components have not been described in detail as not to unnecessarily obscure aspects of the present invention.

Two key factors contributing to the spacing of the read/write elements to the recording disk are the mechanical fly-height of the read/write head over the recording media and any protrusion of the read/write element due to environmental temperature changes or from the read/write operations. The mechanical fly-height of the read/write head is well understood for different positions on the disk and different operating temperatures. Many product generations incorporate an on-board thermal sensor so the operating temperature can be monitored, and in turn the write current can be adjusted accordingly to compensate for changes to the head mechanical fly-height. Furthermore, using thermal fly-height control (TFC), the effects of changes to the read/write element protrusion can also be compensated.

With thermal pole-tip protrusion (T-PTP) caused by environmental changes to operating temperatures, at an elevated temperature the pole-tip may protrude several nanometers due to the mismatch between the respective coefficients of thermal expansion of the materials of which the head slider is constructed. The term “pole-tip protrusion” is used herein to refer to the protrusion of the read/write transducer, generally, rather than to a particular pole of the read/write head. T-PTP is undesirable in most cases because it adversely reduces the flying height. Typical approaches to T-PTP consider only the head structure or materials without considering the air bearing surface, which is an important factor in determining flying height.

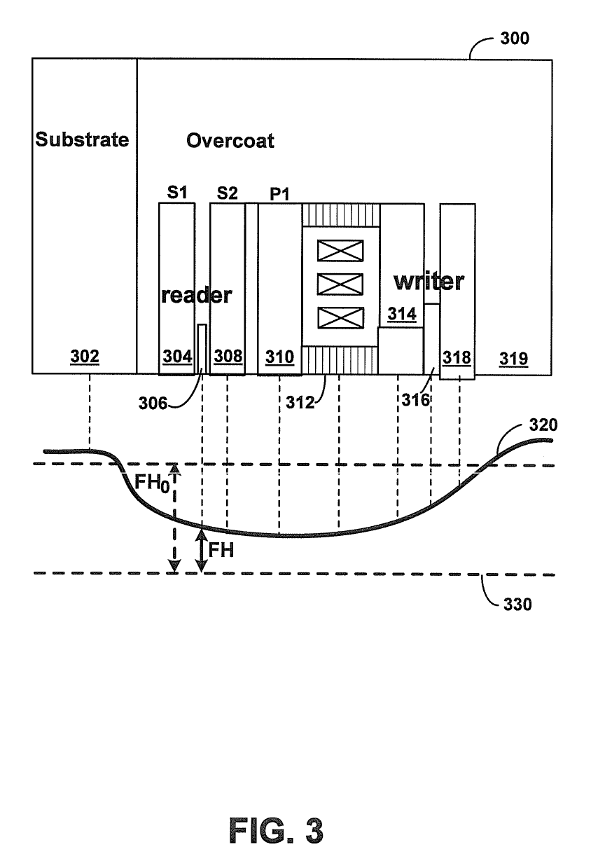

Returning to FIG. 3, a crude example of a typical protrusion profile 320 is illustrated which corresponds to the example air bearing head slider 300. Thus, protrusion profile 320 corresponds to a head slider designed without consideration of the air bearing surface compensation. Protrusion profile 320 depicts the protrusion, and therefore the flying height, along the structure of the head, i.e., relative to the location from the substrate. FH₀ represents a baseline flying height at room temperature (i.e., head is flying but not performing a read or write operation), and FH represents the flying height at an elevated temperature, i.e. FH₀>FH. Protrusion profile 320 illustrates that, at an elevated temperature, portions of the head protrude adversely close to the media (whose location is coincident with line 330) and adversely affect the flying height FH.

For purposes of example, the FH of protrusion profile 320 is relative to the reader element 306. However, the location at which the flying height FH is most critical may vary from implementation to implementation. For example, one may be more concerned with the flying height relative to the writer element 316, or the main pole 318, or any other head component.

### OVERVIEW

A method for neutralizing the flying height sensitivity associated with thermal pole-tip protrusion of an air bearing slider (FH₀=FH within a range of tolerance □, for all operational temperatures) is described. Head material data and air bearing surface compensation data are created, based on which a head/ABS design is created. The head material data comprises at least one material property that is dependent on the process with which the material layer(s) is fabricated. For a non-limiting example, the head material data includes the coefficient of thermal expansion of Al₂O₃ deposited according to a certain “recipe” which characterizes, for non-limiting examples, the deposition process (e.g., sputtering, chemical vapor deposition, evaporation, and the like), chemical composition, pressure, and temperature used to deposit the material on the substrate. The ABS compensation data comprises data about how respective ABS features affect air bearing pressure and, therefore, ABS compensation. For a non-limiting example, the ABS compensation data includes different ABS designs and air bearing surface features with respective pressure profiles, locations of peak pressures, at what temperatures, and the like.

Therefore, a particular head design (i.e., structural and material configuration) can be matched with a particular ABS compensation in order to achieve neutral flying height sensitivity without thermal fly-height control actuation, e.g., an optimized design. Thus, a protrusion profile (or may be referred to as a flying height profile) is calculated or measured for the head/ABS design. Then, it is determined whether or not this protrusion profile meets particular design criteria, e.g., whether □ΔFH□<□. If the head/ABS design does not meet the neutral flying height criteria, then the head/ABS design can be modified based on the head material data in conjunction with the ABS compensation data, and re-tested and iterated if necessary to arrive at a design which provides neutral flying height sensitivity to a range of operational temperatures.

It should be understood by those skilled in the art that various embodiments of the invention increase the performance quality of a hard disk drive (HDD) by enhancing the reliability of the read/write head due to optimized flying heights over the normal range of operating temperatures, and with minimum modification to existing fabrication processes.

Numerous specific embodiments will now be set forth in detail to provide a more thorough understanding of the present technology. The discussion of these detailed embodiments will begin with an overview of a hard disk drive (HDD), and the components connected therein, according to embodiments of the invention. The discussion will then focus on embodiments of the invention that provide a method for neutralizing the flying height sensitivity associated with thermal pole-tip protrusion of an air bearing slider, and corresponding HDD devices.

Although embodiments of the present invention will be described in conjunction with an air bearing slider in a hard disk drive, it is understood that the embodiments described herein are useful outside of the art of HDD design, manufacturing and operation. The utilization of the HDD slider example is only one embodiment and is provided herein merely for purposes of brevity and clarity.

### HARD DISK DRIVE (HDD) CONFIGURATION

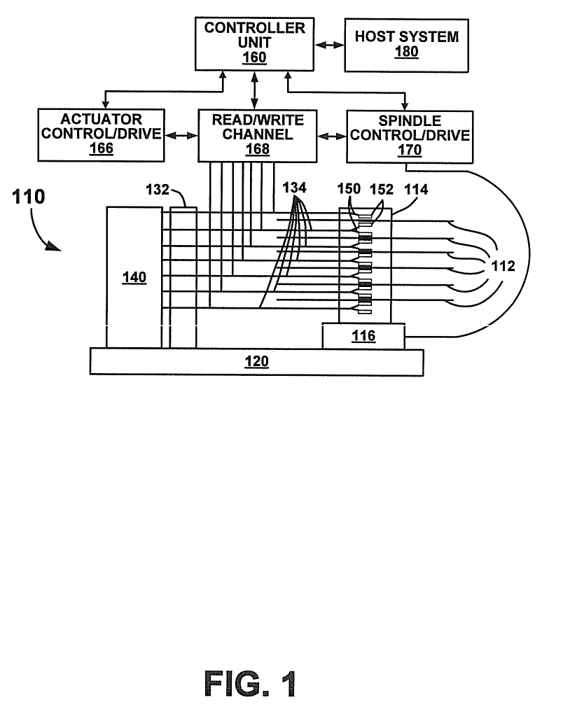

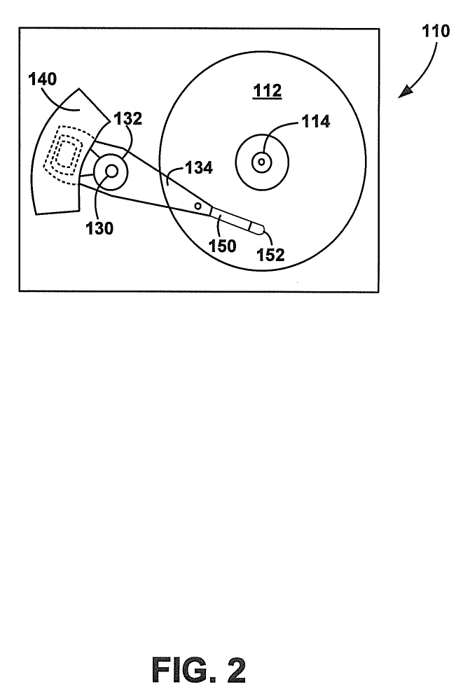

FIG. 1 and FIG. 2 show a side view and a top view, respectively, of a disk drive system designated by the general reference number 110. The disk drive system 110 comprises a plurality of stacked magnetic recording disks 112 mounted to a spindle 114. The disks 112 may be conventional thin film recording disks or other magnetically layered disks. The spindle 114 is attached to a spindle motor 116, which rotates the spindle 114 and disks 112. A chassis 120 provides a housing for the disk drive system 110. The spindle motor 116 and an actuator shaft 130 are attached to the chassis 120. A hub assembly 132 rotates about the actuator shaft 130 and supports a plurality of actuator arms 134. A rotary voice coil motor 140 is attached to chassis 120 and to a rear portion of the actuator arms 134.

A plurality of suspension assemblies 150 are attached to the actuator arms 134. A plurality of heads or transducers on sliders 152 are attached respectively to the suspension assemblies 150. The sliders 152 are located proximate to the disks 112 so that, during operation, the heads or transducers are in electromagnetic communication with the disks 112 for reading and writing. The rotary voice coil motor 140 rotates actuator arms 134 about the actuator shaft 130 in order to move the suspension assemblies 150 to the desired radial position on disks 112. The shaft 130, hub 132, arms 134, and motor 140 may be referred to collectively as a rotary actuator assembly.

A controller unit 160 provides overall control to system 110. Controller unit 160 typically includes (not shown) a central processing unit (CPU), a memory unit and other digital circuitry, although it should be apparent that one skilled in the computer arts could also enable these aspects as hardware logic. Controller unit 160 is connected to an actuator control/drive unit 166 that in turn is connected to the rotary voice coil motor 140. This configuration also allows controller 160 to control rotation of the disks 112. A host system 180, typically a computer system, is connected to the controller unit 160. The host system 180 may send digital data to the controller 160 to be stored on disks 112, or it may request that digital data at a specified location be read from the disks 112 and sent to the system 180. The basic operation of DASD units is well known in the art and is described in more detail in The Magnetic Recording Handbook, C. Dennis Mee and Eric D. Daniel, McGraw-Hill Book Company, 1990.

### NEUTRALIZING FLYING HEIGHT SENSITIVITY OF THERMAL POLE-TIP PROTRUSION

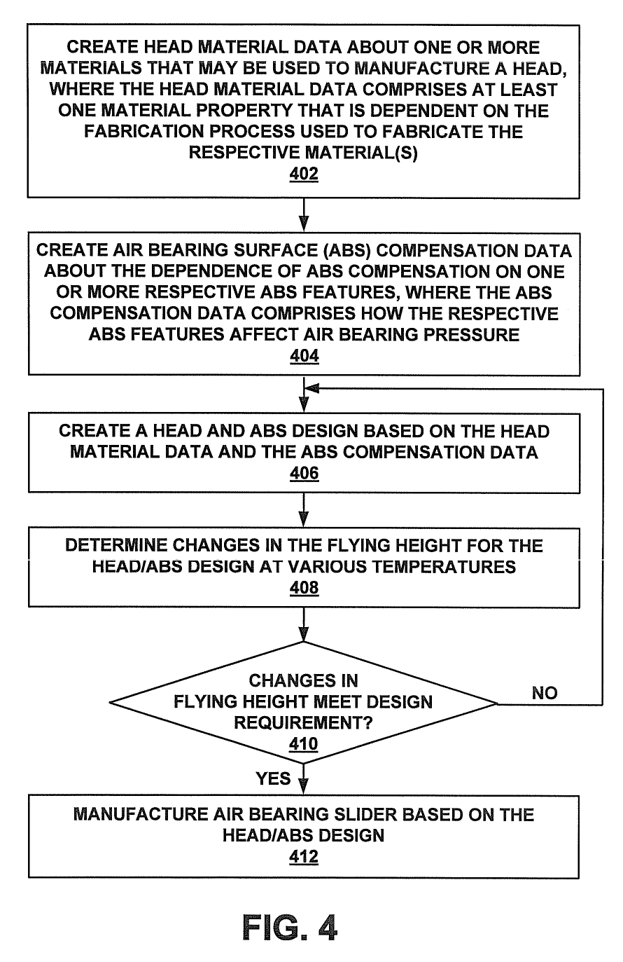

FIG. 4 is a flow diagram illustrating a process for neutralizing flying height sensitivity of thermal pole-tip protrusion, according to an embodiment of the invention.

At block 402 head material data is created, where such data is about one or more materials that may be used to manufacture a magnetic read/write head. For example, a database of head material data may be created which contains various properties of various materials made by various fabrication processes, i.e., various “recipes”. For example, a recipe for a given material may be characterized by the precise chemical composition of the material and/or its source material(s), the type of process used to fabricate the material (e.g., deposition, evaporation), the type of deposition process used, if at all (e.g., sputtering, chemical vapor deposition, plating, pulsed laser deposition, cathodic arc deposition, etc.), environmental parameters under which the material is fabricated (e.g., temperature and pressure), material thickness, and the like.

The recipe used to fabricate a thin-film material affects the properties of the material. For a non-limiting example, according to Hughey et al., Journal of Materials Science 40, (2005) 6345-6355, the coefficient of thermal expansion (CTE) of alumina (Al₂O₃, or aluminum oxide) ranges from 4.2 ppm/K to 7.0 ppm/K depending on the process. Alumina is commonly used as an overcoat in magnetic head manufacturing. For another non-limiting example, silica (SiO₂, or silicon dioxide) can be used as an overcoat. According to Zhao et al., Journal of Applied Physics 85, (1999) 6421-6424, the CTE of silica ranges from 0.5 ppm/K to 4.1 ppm/K. Thus, the head material data comprises at least one material property that is dependent on the fabrication process used to fabricate the respective one or more materials. According to an embodiment, because a fabricated material may have a different coefficient of thermal expansion depending on what deposition process is used to fabricate the material, the head material data comprises the different coefficients of thermal expansion for respective fabrication processes for the one or more materials.

According to an embodiment, the head material data comprises data about the dependence of thermal pole-tip protrusion, or head protrusion, on the one or more materials used to manufacture the read/write head. For example, how much a head or various layers of a head, fabricated according to respective recipes, protrude(s) at different operational temperatures may be included in the head material data.

Various materials with varying material properties, based on their respective fabrication recipes, can be used as undercoats and/or overcoats for a read/write transducer, or pole-tip. Thus, according to an embodiment, the head material data comprises data about a material property of a material used as an undercoat for a read/write transducer. Similarly, according to an embodiment, the head material data comprises data about a material property of a material used as an overcoat for a read/write transducer.

Returning to FIG. 4, at block 404 air bearing surface (ABS) compensation data is created, where such data is about the dependence of ABS compensation on one or more respective ABS features. For example, a database of ABS compensation data may be created which contains data about how respective ABS features affect localized air bearing pressure and/or ABS peak air pressures. According to various embodiments, the ABS compensation data includes one or more of the following: different ABS designs and/or air bearing surface features with respective pressure profiles and locations of peak pressures at certain temperatures, and the like.

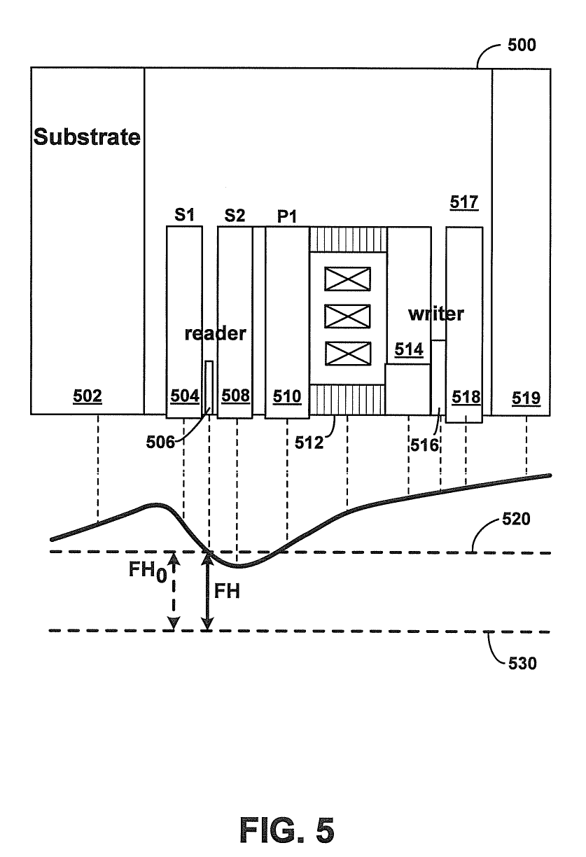

Based on the head material data and the ABS compensation data, one can balance head design and ABS compensation in order to achieve neutral flying height sensitivity to environmental temperatures, which is highly desirable for enhancing reliability. Thus, at block 406 a head and ABS design based on the head material data and the ABS compensation data is created. For example, one could access and work with the various data to develop a head/ABS design having a protrusion profile similar to the protrusion profile 520 depicted in FIG. 5.

### HEAD DESIGNS

According to an embodiment, the head design comprises a first overcoat that envelopes the read and write elements and has a first coefficient of thermal expansion, and a second overcoat lying over the first overcoat and having a second coefficient of thermal expansion which is less than the coefficient of thermal expansion of the substrate on which the read/write head is constructed. For a non-limiting example, the substrate and the first overcoat have CTE=6.5 ppm/K and the second overcoat has CTE=4.2 ppm/K. According to a related embodiment, the first and second overcoats are made of the same material, but are fabricated using different processes thus resulting in the different CTEs. According to another related embodiment, the first and second overcoats are made of different materials with different respective CTEs.

According to an embodiment, the head design comprises a single overcoat that envelopes the read and write elements and has a coefficient of thermal expansion which is less than the coefficient of thermal expansion of the substrate on which the read/write head is constructed. For a non-limiting example, the substrate has CTE=6.5 ppm/K and the single overcoat has CTE=4.2 ppm/K.

According to an embodiment, the head design comprises an undercoat lying over the substrate and under the read and write elements and having a first coefficient of thermal expansion, and an overcoat lying over the undercoat and enveloping the read and write elements and having a second coefficient of thermal expansion which is greater than the first coefficient of thermal expansion. For a non-limiting example, the undercoat has CTE=4.2 ppm/K and the overcoat has CTE=6.5 ppm/K. According to a related embodiment, the undercoat and overcoat are made of the same material, but are fabricated using different processes thus resulting in the different CTEs. According to another related embodiment, the undercoat and overcoat are made of different materials with different respective CTEs.

FIG. 5 is a diagram illustrating an example of a desired protrusion profile 520 for a corresponding example air bearing head slider 500 according to an embodiment of the invention. Protrusion profile 520 corresponds to a head slider designed with consideration to air bearing surface compensation in conjunction with the material configuration, structure and properties, providing neutral flying height sensitivity to T-PTP for all operational temperatures. For example, utilization of the head material data created at block 402 and the ABS compensation data created at block 404, such as at block 406, can result in a head/ABS slider design having a protrusion profile like protrusion profile 520.

Head slider 500 comprises a substrate 502, on which a first shield (S1) 504, a reader element 506, a second shield (S2) 508, a first pole (P1) 510, a coil 512, a stitch pole 514, a main pole 516, and a trailing shield 518 are deposited or otherwise constructed. The foregoing head components are covered with overcoats 519 and 517.

Protrusion profile 520 depicts the protrusion and therefore the flying height along the structure of the head, i.e., relative to the location from the substrate. FH₀ represents a baseline flying height at room temperature, and FH represents the flying height at an elevated temperature, i.e., FH₀>FH. Protrusion profile 520 illustrates that, at an elevated temperature, the flying height FH at the reader element is the same as (within a tolerance range) the baseline flying height FH₀. This is an indication of neutral flying height sensitivity, as desired. Protrusion profile 520 illustrates that, at an elevated temperature, no portions of the head protrude adversely close to the media (whose location is coincident with line 330) and thus adversely affect the flying height FH. It is desirable, but not limiting, to develop a head/ABS design having a protrusion profile generally similar to protrusion profile 520 throughout a full range of operational temperatures.

For purposes of example, the FH of protrusion profile 520 is relative to the reader element 506. However, the location at which the flying height FH is most critical may vary from implementation to implementation. For example, one may be more concerned with the flying height relative to the writer element 516, or the main pole 518, or any other head component.

Returning to FIG. 4, at block 408 the changes in the flying height for the head/ABS design (created at block 406) at various temperatures are determined. For example, a protrusion profile such as protrusion profile 520 of FIG. 5 is generated. According to an embodiment, the changes in flying height for various temperatures are calculated or computed from a head/ABS model based on the head/ABS design created at block 406. According to an embodiment, the changes in flying height for various temperatures are measured from a head/ABS specimen based on the head/ABS design created at block 406. The measurement of ΔFH is well-established in the HDD field, e.g., using a readback signal.

At decision block 410 it is determined whether the changes in the flying height, determined at block 408, meet a particular flying height design criteria or specification, where the flying height design criteria involves the flying height sensitivity to temperature changes. One approach to determining whether the flying height changes meet the criteria is expressed as follows: whether □ΔFH□<□, where □ is specified according to a product requirement. For example, typical flying height sensitivity (without consideration of TFC) is currently on the order of 1 nm/10° C. However, desirable flying height sensitivity, and one believed achievable by practicing embodiments of the present invention, is on the order of 0.5 nm/10° C., or 2.5 nm for a typical 50° C. operating temperature range.

At block 412, if the decision at decision block 410 is affirmative, i.e., if the changes in flying height meet the particular flying height design criteria, then an air bearing head/slider assembly is manufactured based on the head/ABS design created at block 406. Likewise, if the decision at decision block 410 is negative, i.e., if the changes in flying height do not meet the particular flying height design criteria, then flow returns to block 406 to create another head/ABS design based on the head material data and the ABS compensation data, which is tested at block 408, 410, and so on. Similarly and more practically, if the decision at decision block 410 is negative, then control returns to the block 406 and the current head/ABS design is modified and tested at block 408, 410, and so on.

Hence, the iterative process depicted in FIG. 4 is an efficient and effective method for neutralizing flying height sensitivity on thermal pole-tip protrusion, balancing the effects of both head materials, processes and structures with air bearing surface compensation. The potential effectiveness of the foregoing process is exemplified in describing the following case study.

### CASE STUDY

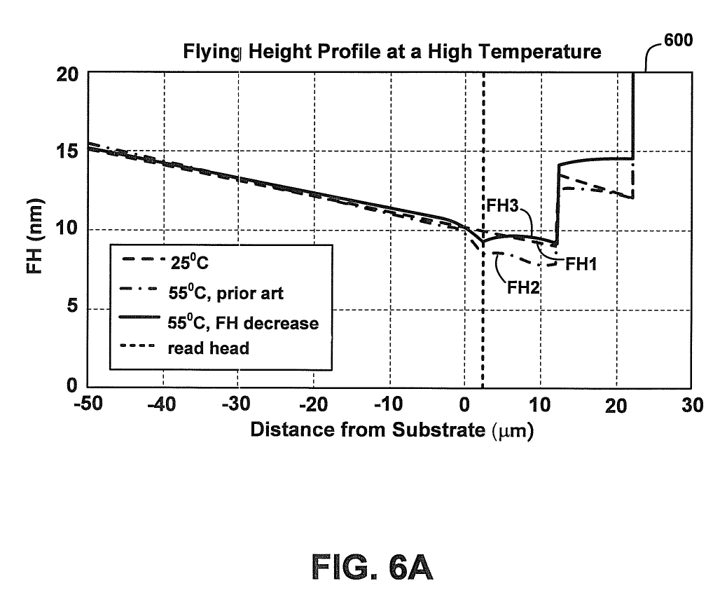

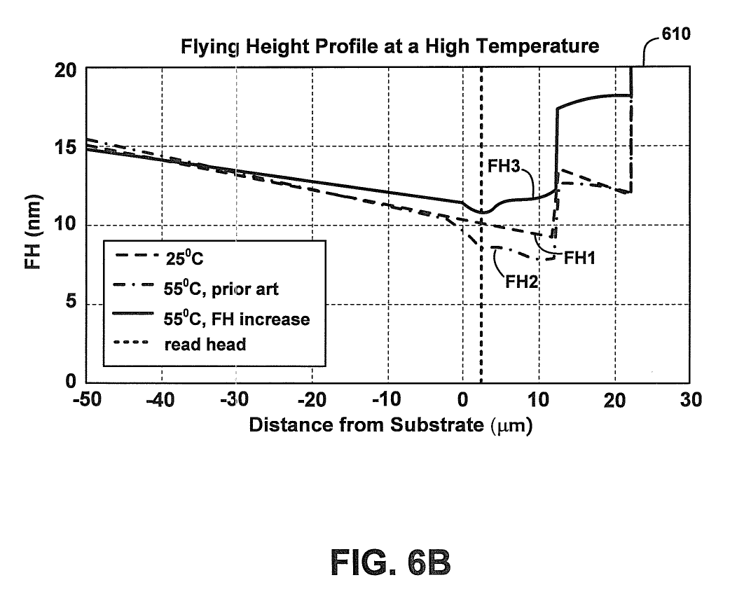

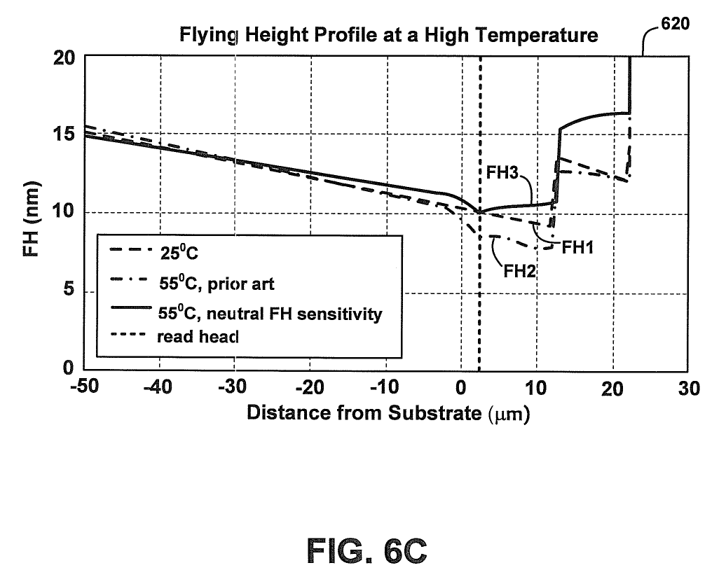

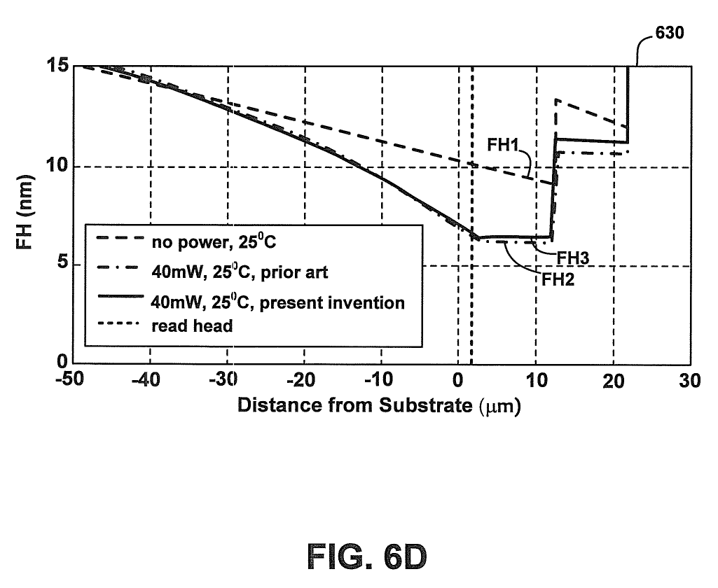

FIGS. 6A-6D are diagrams illustrating various cases studied to show the effectiveness of the teachings and embodiments presented herein.

FIG. 6A is a diagram 600 which corresponds to Case 1, where neutral flying height sensitivity is not quite obtained. Diagram 600 depicts a comparison of the flying height profile along an air bearing surface at a 30° C. (25° C. to 55° C.) ambient temperature rise (with no internal TFC heat source), based on simulation results. The head design corresponding to FIG. 6A comprises one layer of overcoat with a CTE of 5.5 ppm/K.

Diagram 600 illustrates a flying height profile (FH1) for the given head/ABS design at a 25° C. “normal” operating temperature. FH1 shows a flying height around 10 nm at the read head. Diagram 600 illustrates a flying height profile (FH2) for the given head/ABS design at a 55° C. operating temperature, based on a prior approach involving only head material and structures without consideration of ABS compensation. FH2 shows a flying height around 8.5 nm at the read head. Diagram 600 illustrates a flying height profile (FH3) for the given head/ABS design at a 55° C. operating temperature, according to an embodiment of the invention. FH3 shows a flying height around 9.3 nm at the read head. Compared to FH2, FH3 increases at a higher temperature with this head design. However, the head protrusion and ABS compensation are not balanced, i.e., the flying height at the read element needs to be pulled up a bit more to more closely approach FH1.

FIG. 6B is a diagram 610 which corresponds to Case 2, where neutral flying height sensitivity is not quite obtained. Diagram 610 depicts a comparison of the flying height profile along an air bearing surface at a 30° C. (25° C. to 55° C.) ambient temperature rise (with no internal TFC heat source), based on simulation results. The head design corresponding to FIG. 6B comprises one layer of overcoat with a CTE of 4.0 ppm/K.

Diagram 610 illustrates a flying height profile (FH1) for the given head/ABS design at a 25° C. “normal” operating temperature. FH1 shows a flying height around 10 nm at the read head. Diagram 610 illustrates a flying height profile (FH2) for the given head/ABS design at a 55° C. operating temperature, based on a prior approach involving only head material and structures without consideration of ABS compensation. FH2 shows a flying height around 8.5 nm at the read head. Diagram 610 illustrates a flying height profile (FH3) for the given head/ABS design at a 55° C. operating temperature, according to an embodiment of the invention. FH3 shows a flying height around 11 nm at the read head. Compared to FH2, FH3 increases at a higher temperature with this head design. However, the head protrusion and ABS compensation are not balanced, i.e., the flying height at the read element needs to be pulled down a bit to more closely approach FH1.

FIG. 6C is a diagram 620 which corresponds to Case 3, where neutral flying height sensitivity is obtained using an embodiment of the invention. Diagram 620 depicts a comparison of the flying height profile along an air bearing surface at a 30° C. (25° C. to 55° C.) ambient temperature rise (with no internal TFC heat source), based on simulation results. The head design corresponding to FIG. 6C comprises one layer of overcoat with a CTE of 4.8 ppm/K.

Diagram 620 illustrates a flying height profile (FH1) for the given head/ABS design at a 25° C. “normal” operating temperature. FH1 shows a flying height around 10 nm at the read head. Diagram 620 illustrates a flying height profile (FH2) for the given head/ABS design at a 55° C. operating temperature, based on a prior approach involving only head material and structures without consideration of ABS compensation. FH2 shows a flying height around 8.5 nm at the read head. Diagram 620 illustrates a flying height profile (FH3) for the given head/ABS design at a 55° C. operating temperature, according to an embodiment of the invention. FH3 shows a flying height around 10 nm at the read head, confirming neutral FH sensitivity at this temperature with this head/ABS design.

FIG. 6D is a diagram 630 which corresponds to Case 4, where thermal fly-height control is not affected by neutral flying height sensitivity obtained using an embodiment of the invention. Diagram 630 depicts a comparison of the flying height profile along an air bearing surface at a 25° C. ambient temperature for various scenarios, based on simulation results. The head design corresponding to FIG. 6D comprises one layer of overcoat with a CTE of 4.8 ppm/K.

Diagram 630 illustrates a flying height profile (FH1) for the given head/ABS design at a 25° C. “normal” operating temperature. FH1 shows a flying height around 10 nm, with no thermal actuation, at the read head. Diagram 630 illustrates a flying height profile (FH2) for the given head/ABS design at a 25° C. operating temperature, based on a prior approach involving only head material and structures without consideration of ABS compensation, and with 40 mW thermal actuation. FH2 shows a flying height around 6.5 nm at the read head. Diagram 630 illustrates a flying height profile (FH3) for the given head/ABS design at a 25° C. operating temperature, according to an embodiment of the invention, and with 40 mW thermal actuation. FH3 shows a flying height around 6.5 nm at the read head, confirming that embodiments according to the invention are as effective as the prior approach, in conjunction with thermal fly-height control. Stated otherwise, diagram 630 shows that thermal fly-height control is not affected by neutral flying height sensitivity obtained using an embodiment of the invention.

It should be understood that although various embodiments of the present invention are described in the context of a neutral sensitivity read/write head-air bearing slider in a hard disk drive (HDD), the foregoing embodiments are merely exemplary of various implementations of principles of the present technology. Therefore, it should be understood that various embodiments of the invention described herein may apply to any devices, configurations, or systems in which air bearing sliders are employed.

The foregoing descriptions of specific embodiments of the present invention have been presented for purposes of illustration and description. They are not intended to be exhaustive or to limit the invention to the precise forms disclosed, and many modifications and variations are possible in light of the above teachings. The embodiments described herein were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method for neutralizing flying height sensitivity of a magnetic slider thermal pole-tip protrusion, the method comprising:
(a) creating head material data about one or more respective materials, said head material data comprising at least one material property that is dependent on the fabrication process used to fabricate said one or more respective materials;
(b) creating air bearing surface (ABS) compensation data about the dependence of ABS compensation on one or more respective ABS features, said ABS compensation data comprising how said respective ABS features affect air bearing pressure;
(c) creating a head and ABS design based on said head material data and said ABS compensation data;
(d) determining a change in flying height at respective temperatures for said head and ABS design;
(e) determining whether said change in flying height meets a particular flying height design criteria involving flying height sensitivity to temperature changes; and
(f) if said change in flying height meets said particular flying height design criteria, then manufacturing an air bearing slider based on said head and ABS design;
(g) if said change in flying height does not meet said particular flying height design criteria, then modifying said head and ABS design based on said head material data and said ABS compensation data and repeating (c)-(g).

2. The method recited in claim 1, wherein creating head material data comprises creating data about the dependence of head protrusion on said one or more materials.

3. The method recited in claim 1, wherein said least one material property is the coefficient of thermal expansion of said one or more respective materials.

4. The method recited in claim 1, wherein creating head material data comprises creating data about at least one material property of a material used as an undercoat for said pole-tip.

5. The method recited in claim 1, wherein creating head material data comprises creating data about at least one material property of a material used as an overcoat for said pole-tip.

6. The method recited in claim 1, wherein determining a change in flying height comprises computing said change in flying height.

7. The method recited in claim 1, wherein determining a change in flying height comprises measuring said change in flying height.

8. The method recited in claim 1, wherein creating head material data comprises creating data about fabrication recipes for achieving particular coefficients of thermal expansion for said one or more respective materials.

9. The method recited in claim 1, wherein creating ABS compensation data comprises creating data about where a peak air pressure occurs on a particular air bearing surface design.

10. The method recited in claim 1, wherein creating a head and ABS design comprises matching a particular head design with a particular ABS compensation design, which neutralizes flying height sensitivity to temperature without thermal fly-height control actuation.

11. The method recited in claim 1, wherein determining whether said change in flying height meets a particular flying height design criteria comprises determining whether said change in flying height is within a 2.5 nm range.

12. The method recited in claim 1, wherein determining a change in flying height at respective temperatures for said head and ABS design and determining whether said change in flying height meets a particular flying height design criteria comprises determining at a location of a reader element.

13. The method recited in claim 1, wherein determining a change in flying height at respective temperatures for said head and ABS design and determining whether said change in flying height meets a particular flying height design criteria comprises determining at a location of a writer element.

14. A hard disk drive device comprising:
a housing;
a magnetic storage medium coupled with said housing, said magnetic storage medium rotating relative to said housing;
an actuator arm coupled with said housing, said actuator arm moving relative to said magnetic storage medium;
an air bearing slider assembly having a substantially neutral flying height sensitivity to temperature changes, said air bearing slider assembly comprising a magnetic recording read/write head comprising a write element which magnetically writes data to said magnetic storage medium and a read element which magnetically reads data from said magnetic storage medium, said air bearing slider assembly comprising
one or more layers of (a) head overcoat or (b) head undercoat or (c) head overcoat and head undercoat, said one or more layers having a lower coefficient of thermal expansion than a substrate on which said read/write head is constructed, and
an air bearing surface which compensates, over a particular range of operational temperatures, for changes in flying height of said write element or said read element wherein said changes in flying height are based at least in part on the one or more layers.

15. The hard disk drive device recited in claim 14,
wherein said one or more layers comprises a first head overcoat and a second head overcoat;
wherein said first head overcoat envelopes said read element and said write element and has a first coefficient of thermal expansion;
wherein said second head overcoat lies over said first head overcoat and has a second coefficient of thermal expansion; and
wherein said second coefficient of thermal expansion is less than the coefficient of thermal expansion of a substrate on which said read/write head is constructed.

16. The hard disk drive device recited in claim 15, wherein said second coefficient of thermal expansion is less than said first coefficient of thermal expansion.

17. The hard disk drive device recited in claim 16, wherein said first head overcoat is constructed of a first material by a first process and said second head overcoat is constructed of said first material by a second process.

18. The hard disk drive device recited in claim 16, wherein said first head overcoat is constructed of a first material and said second head overcoat is constructed of a second material, and wherein said first material is a different material than said second material.

19. The hard disk drive device recited in claim 15, wherein said first coefficient of thermal expansion is substantially equal to the coefficient of thermal expansion of a substrate on which said read/write head is constructed.

20. The hard disk drive device recited in claim 14,
wherein said one or more layers comprises a single head overcoat which envelopes said read element and said write element and has a coefficient of thermal expansion less than the coefficient of thermal expansion of a substrate on which said read/write head is constructed.

21. The hard disk drive device recited in claim 14,
wherein said one or more layers comprises a head undercoat and a head overcoat;
wherein said head undercoat lies over said substrate and under said read element and said write element and has a first coefficient of thermal expansion;
wherein said head overcoat lies over said head undercoat and envelopes said read element and said write element and has a second coefficient of thermal expansion; and
wherein said first coefficient of thermal expansion is less than said second coefficient of thermal expansion.

22. The hard disk drive device recited in claim 21, wherein said head undercoat is constructed of a first material by a first process and said head overcoat is constructed of said first material by a second process.

23. The hard disk drive device recited in claim 21, wherein said head undercoat is constructed of a first material and said head overcoat is constructed of a second material, and wherein said first material is a different material than said second material.
